(19) United States
(12) Patent Application Publication
(10) Pub. No.: US 2007/0211378 A1
(43) Pub. Date: Sep. 13, 2007

(54) Method of manufacturing magnetic head and magnetic head

(75) Inventor: Kiyotaka Nara, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/434,481

(22) Filed: May 15, 2006

(30) Foreign Application Priority Data
Mar. 8, 2006 (JP) 2006-062176

(51) Int. Cl. G11B 5/147

(52) U.S. Cl. 360/126

(57) ABSTRACT

The method is capable of manufacturing a reliable magnetic head, in which an upper magnetic coil can be securely insulated from a coil and variation of coil resistance can be restrained. The method of manufacturing a magnetic head having a write-head comprises the steps of: forming a recording coil of the write-head formed in a workpiece; coating a surface of a coil forming area of the write-head, in which the recording coil is formed, other than a front end part of a lower magnetic pole of the write-head, with a protection layer, which prevents the recording coil from being etched by ion milling; and etching a pole end section of the write-head, by ion milling, so as to have a prescribed width.

### BACKGROUND OF THE INVENTION

The present invention relates to a method of manufacturing a magnetic head and a magnetic head, more precisely relates to a method or manufacturing a write-head of a magnetic head and a magnetic head having a unique structure.

A conventional magnetic head of a magnetic disk unit is shown in FIG. 4. The magnetic head comprises: a read-head 8, in which a reproducing element 5 is sandwiched between a lower shielding layer 6 and an upper shielding layer 7; and a write-head 10, in which a write-gap 11 is formed between a lower magnetic pole 12 and an upper magnetic pole 13. The write-head 10 has recording coils 14, which generates a write-magnetic field between end sections of the magnetic poles 12 and 13. The recording coils 14 are wound around a connecting section 15. These days, winding number of the coils 14 are reduced so as to miniaturize the magnetic head. Thus, the coils 14 are layered as shown in FIG. 4.

The write-head 10 of the magnetic head is formed by the steps of: forming the lower magnetic pole 12 and the coils 14 on a surface of a wafer (a workpiece) by sputtering or plating; forming a nonmagnetic layer, which acts as the write-gap 11, by sputtering; forming a resist layer 16, which raises a rear part of the end section of the upper magnetic pole 13; and forming the upper magnetic pole 13 by plating. The resist layer 16 is optically exposed and developed, so that the end section of the upper magnetic pole 13 has a prescribed apex angle θ.

After forming the upper magnetic pole 13, both sides of the magnetic poles 12 and 13 are etched by ion milling so as to make a pole end section of the write-head narrow (see Japanese Patent Gazette No. 2000-11320).

In FIG. 5, the end sections of the magnetic poles 12 and 13 are made narrow by FIB (focused ion beam) etching. Both sides of a core is carved from a magnetic layer, which becomes the upper magnetic pole 13, toward the lower magnetic pole 12 so as to make the end sections of the magnetic poles 12 and 13, which sandwich the write-gap 11, narrow.

When the write-head is ion-milled from the upper magnetic pole 13 to the lower magnetic pole 12 so as to make the pole end section narrow, the surface of the wafer other than a specific area, which will be the pole end section, is coated with resist. However, when the resist is patterned, the resist slightly extends beyond the pole end section. Further, in recent magnetic heads, core widths are narrower and narrower, so it takes a long time to ion-mill the magnetic poles. Therefore, when the magnetic poles 12 and 13 are etched by ion milling, the etching badly influences the coils 14, which are located under the upper magnetic pole 13.

Namely, in the conventional magnetic head, a nonmagnetic layer, which acts as the write-gap 11, and the resist layer 16, is formed on the coils 14. When the pole end section is ion-milled as indicated by arrows shown in FIG. 4, the coils 14 are protected by the nonmagnetic layer and the resist layer 16. However, if the etching time is long, the nonmagnetic layer and the resist layer 16 are carved, so that the coils 14 are etched.

If the coils 14 are etched when the pole end section of the write-head is carved by etching (ion milling), the coils 14 cannot be insulated from the upper magnetic pole 13, and resistances and inductances of the coils 14 are varied.

### SUMMARY OF THE INVENTION

The present invention was conceived to solve the above described problems.

An object of the present invention is to provide a method of manufacturing a reliable magnetic head, in which an upper magnetic coil can be securely insulated from a coil and variation of coil resistance can be restrained, and said magnetic head.

To achieve the object, the present invention has following constitutions.

Namely, the method of manufacturing a magnetic head having a write-head comprises the steps of: forming a recording coil of the write-head formed in a workpiece; coating a surface of a coil forming area of the write-head, in which the recording coil is formed, other than a front end part of a lower magnetic pole of the write-head, with a protection layer, which prevents the recording coil from being etched by ion milling; and etching a pole end section of the write-head, by ion milling, so as to have a prescribed width.

In the method, the coating step may comprise the steps of: coating an area, other than the area to be coated with the protection layer, with resist; forming the protection layer on a surface of the workpiece, which has been coated with the resist; and removing a part of the protection layer by lift-off, so that the protection layer is left on the surface of the coil forming area.

The method may further comprise the step of flattening a surface of the workpiece, and the flattening step is performed between the forming step and the coating step. By flattening the surface of the workpiece, the highly accurate upper magnetic pole can be formed.

The method may further comprise the steps of forming a write-gap with resist. In this case, a part of the resist forming the write-gap, which corresponds to a rear part of the pole end section, is raised, and this step is performed after the coating step.

In the method, the protection layer may be an alumina film. Since rate of etching alumina, by ion milling, is low, the coil can be effectively protected from the ion milling.

The magnetic head of the present invention comprises: a lower magnetic pole; an upper magnetic pole; a write-gap being formed between the lower magnetic pole and the upper magnetic pole; a recording coil being sandwiched between the lower magnetic pole and the upper magnetic pole; a protection layer coating a surface of a coil forming area, in which the recording coil is formed, other than a front end part of the lower magnetic pole; and a resist layer coating a surface of the protection layer. Note that, the protection layer prevents the coil from carving in the ion milling process, so it is made of a specific material whose ion milling rate is low.

In the magnetic head, the resist layer may make a rear part of a pole end section of the write-head has a prescribed apex angle.

In the magnetic head, the front end part and the recording coil may have polished faces, which are included in the same plane.

Further, the magnetic head may further comprise a magnetic layer being provided on a surface of the front end part, the magnetic layer having high saturation magnetic flux density. With this structure, the write-head is capable of performing high density recording.

In the magnetic head, the protection layer may be made of alumina.

By employing the method of the present invention, when the pole end section of the write-head is processed by ion milling, the recording coil, which is provided under the upper magnetic pole, can be protected by the protection layer. Therefore, short circuit between the coil and the upper magnetic pole and variation of resistance and inductance of the coil can be prevented, so that the highly reliable magnetic head can be produced. Further, the magnetic head of the present invention is not damaged in the ion milling process, so it can be provided as the highly reliable magnetic head.

### BRIEF DESCRIPTION OF THE DRAWINGS

According to the present invention will now be described by way of examples and with reference to the accompanying drawings, in which:

FIGS. 1A-1C are sectional views showing the process of flattening a surface of a wafer so as to flatten a surface of a coil;

FIGS. 2A-2C are sectional views showing the process of forming a protection layer on the coil;

FIGS. 3A-3C are sectional views showing the process of forming an upper magnetic pole;

FIG. 4 is a sectional view of the conventional magnetic head;

FIG. 5 is an explanation view, in which the pole end section of the conventional write-head is etched by FIB; and

FIG. 6 is an explanation view, in which the pole end section of the write-head is ion-milled.

### DETAILED DESCRIPTION OF THE EMBODIMENTS

Preferred embodiments of the present invention will now be described in detail with reference to the accompanying drawings.

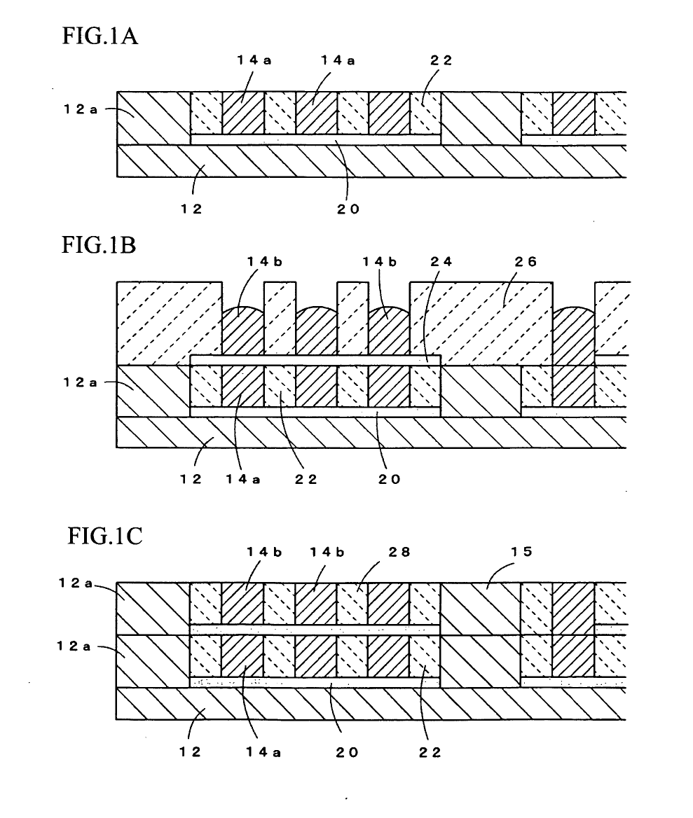

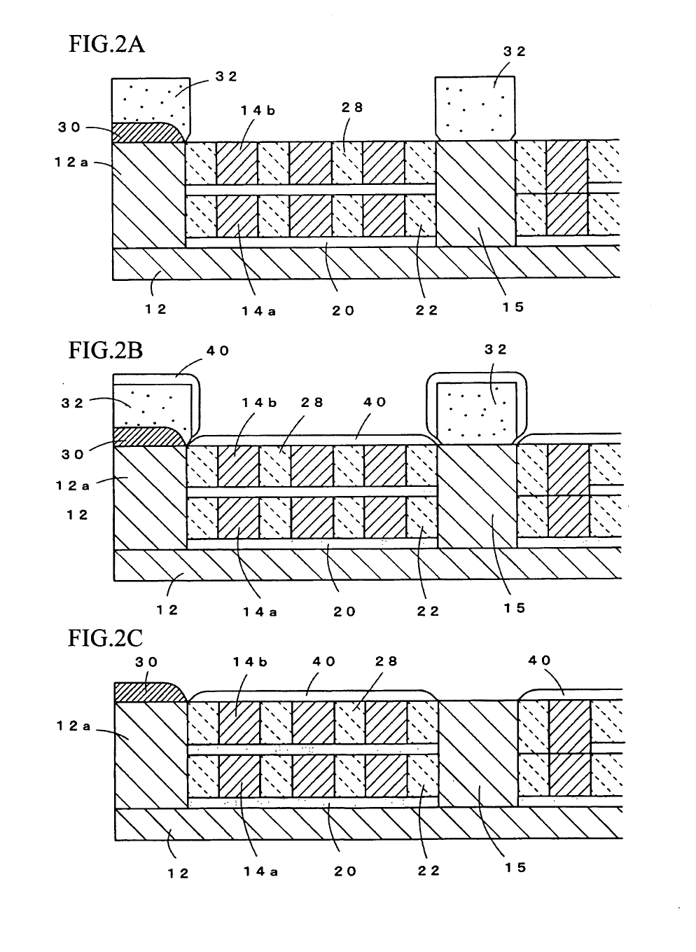

An embodiment of the method of manufacturing a unique write-head is shown in FIGS. 1A-2C.

FIGS. 1A-1C show a process until forming a lower magnetic pole 12 and an upper coil 14b.

In FIG. 1A, a lower shielding layer and a reproducing element (not shown) are formed on a surface of a wafer (workpiece), then the lower magnetic pole 12, a lower coil 14a and a lower front end part 12a of the lower magnetic pole 12 are formed thereon. To precisely form the upper coil 14b, the surface of the wafer is flattened by CMP (Chemical Mechanical Polishing). An insulating layer 20 made of alumina electrically insulates the lower magnetic pole 12 from the coil 14a. Resist 22 insulates a winding wire of the coil 14a.

In FIG. 1B, a surface of the lower coil 14a is coated with an insulating layer 24, then the surface of the wafer is coated with resist 26. Further, the resist 26 is grooved along the pattern of the upper coil 14b, and the upper coil 14b is formed by plating.

In FIG. 1C, the resist 26 is removed, and an upper front end part 12a of the lower magnetic pole 12 is formed. A space in a winding wire of the coil 14b is filled with resist 28, and the surface of the wafer is flattened by CMP. The wafer is flattened by coating the entire surface of the wafer with alumina and chemical-mechanical-polishing the surface of the wafer until upper faces of the coil 14b and the front end part 12a are exposed.

FIGS. 2A-2C show the characteristic steps of the present embodiment, and they show a process until forming an alumina protection layer 40, which covers the surface of the upper coil 14b.

In FIG. 2A, the surface of the wafer is flattened, then a magnetic layer 30, which has high magnetic flux density, is formed on a surface of the front end part 12a. Next, the surface of the wafer is coated with resist 32, and the resist 32 is optically exposed and developed so that the surface of the front end part 12a is coated with the resist 32. The resist 32 is patterned so as to securely coat the front end part 12a and expose the surface of a part of the coil 14b, which is located near the front end part 12a. In the present embodiment, the resist 32 is patterned to expose the part of the coil 14b located between the front end part 12a and a connecting section 15; another part, which is located on the connecting section 15, is coated with the resist 32. Since the resist 32 is corresponded to the exposed surface of the front end part 12a and patterned, the resist 32 can be highly precisely patterned.

In FIG. 2B, alumina layer, which acts as the protection layer 40 of the coil 14b, is formed on the surface of the wafer, which is partially coated with the resist 32, by sputtering. The alumina layer 40 coats the surfaces of the resist 32, the coil 14b and the resist 28. Thickness of the alumina layer 40 is about 300 nm.

In FIG. 2C, parts of the protection layer 40, which coat the resist 32, are removed, by a lift-off process, together with the resist 32. By the lift-off process, the magnetic layer 30, which is formed on the surface of the front end part 12a and coated with the resist 32, is exposed; the coil 14b and the resist 28 and the connecting section 15, which are located on the rear side of the front end part 12a, are coated with the protection layer 40.

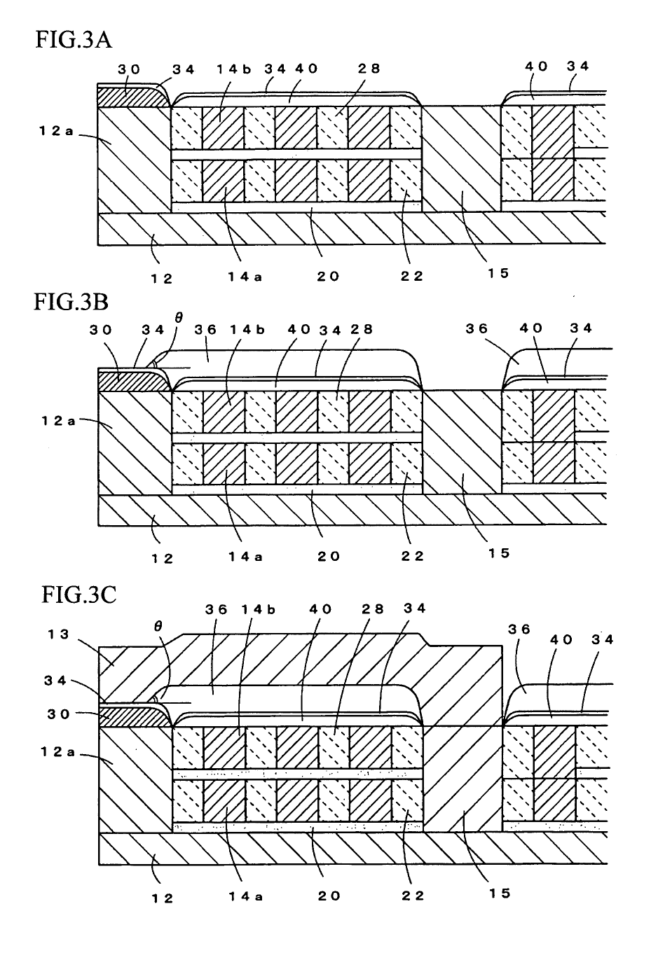

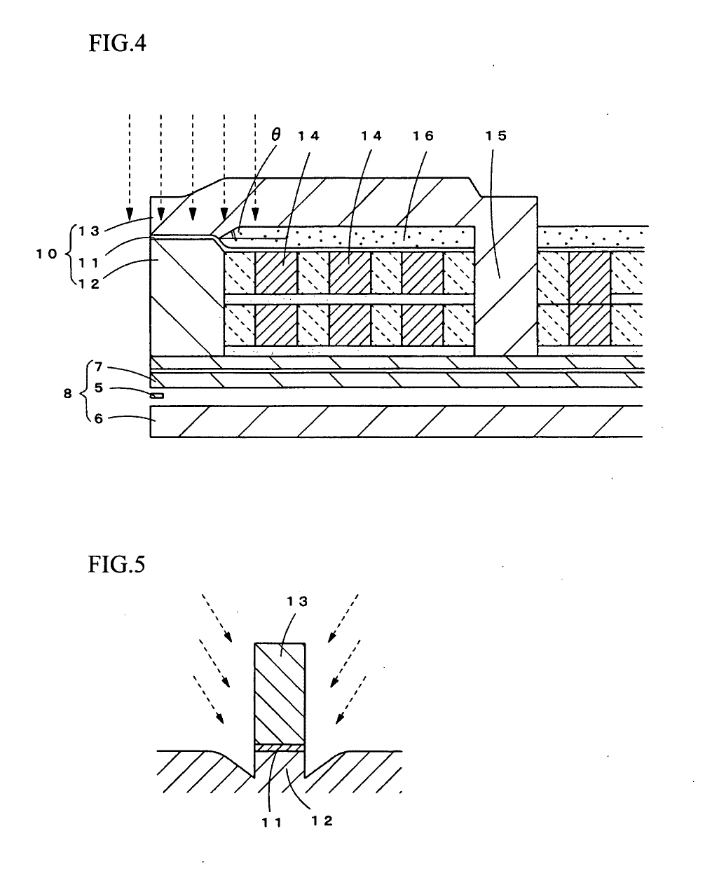

FIGS. 3A-3C show a process of forming an upper magnetic pole 13.

In FIG. 3A, a nonmagnetic material 34 is sputtered on the surface of the wafer so as to form a write-gap. For example, the nonmagnetic material 34 is SiO₂.

In FIG. 3B, resist 36 is coated, optically exposed and developed, so that a prescribed apex angle θ is formed in a rear part of the pole end section of the write-head. The apex angle θ can be adjusted by selecting a material of the resist 36 and an exposing condition. After the resist 36 is exposed and developed to form the prescribed apex angle θ, the resist 36 is baked and hardened. In the present embodiment, after forming the coil 14b, the surface of the wafer is chemical-mechanical-polished so as to flatten the surface and the apex angle θ is formed. Therefore, the apex angle θ can be highly precisely formed.

In FIG. 3C, the upper magnetic pole 13 is formed on the surface of the wafer, on which the resist 36 has been formed. The upper magnetic pole 13 is made of a magnetic material, which is raised by plating.

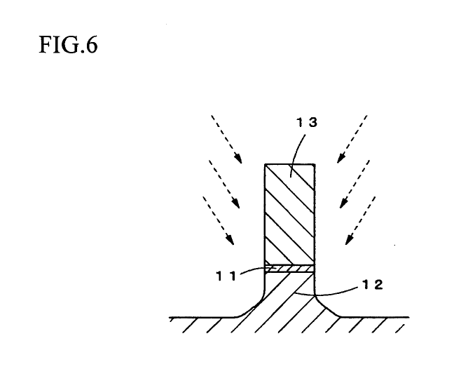

After forming the upper magnetic pole 13, the end sections of the magnetic poles 12 and 13 are ion-milled as shown in FIG. 6 so as to narrow the pole end section of the write-head. When the ion milling is performed, the surface of the wafer is coated with the resist, but the pole end section is exposed and etched.

In the method of the present embodiment, the end section of the upper magnetic pole 13 is etched, and the sides of the lower magnetic pole 12 are etched as if they are carved. At that time, the coil 14b, which is located close to the lower magnetic pole 12, is coated with the alumina protection layer 40, so that the protection layer 40 prevents the coil 14b from being etched. Since rate of etching alumina, by ion milling, is low, the alumina protection layer 40 is capable of effectively protecting the coil 14b from etching or ion milling.

In the present embodiment, the surface of the coil 14b is coated with the alumina protection layer 40, so that the surface of the coil 14b, which may be badly influenced by etching or ion milling, can be protected from being carved by ion milling. Other materials, e.g., oxides, nitrides, whose etching rates are low, may be used as the materials of the protection layer 40.

By coating the surface of the coil 14b with the protection layer 40, the problems of the conventional magnetic head, such as short circuit between the coil 14b and the upper magnetic pole 13, which is caused by etching the coil 14b when the pole end part of the write-head is ion-milled, and variation of resistance and inductance of the coil 14b, can be solved.

The inventor measured coil resistance, coil inductance, etc. of the magnetic head manufactured by the method of the present embodiment and the conventional magnetic head. The results are shown as TABLE 1.

TABLE 1

| | MAGNETIC HEAD | MAGNETIC HEAD | |
|---|---|---|---|
| | MANUFACTURED | PRODUCED BY | |
| | BY THE METHOD | THE | |
| | OF THE PRESENT | CONVENTIONAL | |
| | EMBODIMENT | METHOD | EFFECT |
| COIL RESISTANCE 3σ | 0.1 Ω | 0.4 Ω | IMPROVED |
| | | | ABOUT |
| | | | 80% |
| COIL INDUCTANCE 3σ | 0.6 nH | 3.6 nH | IMPROVED |
| | | | ABOUT |
| | | | 80% |
| PERCENT OF INSULATION | 0% | 80% | IMPROVED |
| FAILURE BETWEEN COIL | | | ABOUT |
| AND MAGNETIC POLE | | | 80% |

According to TABLE 1, the method of the present embodiment, in which the surface of the coil 14b was coated with the protection layer 40, more effectively restrained variations of resistance and inductance of the coil 14b than the conventional method. Further, the method of the present embodiment securely prevented short circuit between the coil 14a and the upper magnetic pole 13.

Note that, in the above described embodiment, the magnetic head includes two layers of the coils, but number of layers of the coils is not limited. The magnetic head may include one coil, or three or more number of layered coils. The magnetic head of the above described embodiment is a horizontal recording head, but the present invention can be applied to a vertical recording head. In case that a coil for recording data is etched when a pole end section or a trailing shield of a vertical recording head is ion-milled, the present invention may be applied.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of manufacturing a magnetic head having a write-head, comprising the steps of:
forming a recording coil of the write-head formed in a workpiece;
coating a surface of a coil forming area of the write-head, in which the recording coil is formed, other than a front end part of a lower magnetic pole of the write-head, with a protection layer, which prevents the recording coil from being etched by ion milling; and
etching a pole end section of the write-head, by ion milling, so as to have a prescribed width.

2. The method according to claim 1,
wherein said coating step comprises the steps of:
coating an area, other than the area to be coated with the protection layer, with resist;
forming the protection layer on a surface of the workpiece, which has been coated with the resist; and
removing a part of the protection layer by lift-off,
whereby the protection layer is left on the surface of the coil forming area.

3. The method according to claim 1,
further comprising the step of flattening a surface of the workpiece,
wherein said flattening step is performed between said forming step and said coating step.

4. The method according to claim 2,
further comprising the step of flattening a surface of the workpiece,
wherein said flattening step is performed between said forming step and said coating step.

5. The method according to claim 3,
further comprising the steps of forming a write-gap with resist,
wherein a part of the resist forming the write-gap, which corresponds to a rear part of the pole end section, is raised, and
wherein said step is performed after said coating step.

6. The method according to claim 1,
wherein the protection layer is an alumina film.

7. The method according to claim 2,
wherein the protection layer is an alumina film.

8. The method according to claim 3,
wherein the protection layer is an alumina film.

9. The method according to claim 4,
wherein the protection layer is an alumina film.

10. The method according to claim 5,
wherein the protection layer is an alumina film.

11. A magnetic head,
comprising:
a lower magnetic pole;
an upper magnetic pole;
a write-gap being formed between said lower magnetic pole and said upper magnetic pole;
a recording coil being sandwiched between said lower magnetic pole and said upper magnetic pole;
a protection layer coating a surface of a coil forming area, in which the recording coil is formed, other than a front end part of said lower magnetic pole; and
a resist layer coating a surface of said protection layer.

12. The magnetic head according to claim 11,
wherein said resist layer makes a rear part of a pole end section of the write-head have a prescribed apex angle.

13. The magnetic head according to claim 11,
wherein the front end part and said recording coil have abraded faces, which are included in the same plane.

14. The magnetic head according to claim 11,
further comprising a magnetic layer being provided on a surface of the front end part, said magnetic layer having high saturation magnetic flux density.

15. The magnetic head according to claim 12,
further comprising a magnetic layer being provided on a surface of the front end part, said magnetic layer having high saturation magnetic flux density.

16. The magnetic head according to claim 13,
further comprising a magnetic layer being provided on a surface of the front end part, said magnetic layer having high saturation magnetic flux density.

17. The magnetic head according to claim 11,
wherein said protection layer is made of alumina.

18. The magnetic head according to claim 12,
wherein said protection layer is made of alumina.

19. The magnetic head according to claim 13,
wherein said protection layer is made of alumina.
